(19) United States
(12) Patent Application Publication
(10) Pub. No.: US 2016/0380454 A1
(43) Pub. Date: Dec. 29, 2016

(54) WIRELESS CHARGING SLEEVE FOR ELECTRONIC DEVICES

(71) Applicant: INTEL CORPORATION, SANTA CLARA, CA (US)

(72) Inventors: Andrew Larson, Hillsboro, OR (US); Patrick W. Chewning, Beaverton, OR (US); Amin Godil, Beaverton, OR (US); Ralph V. Miele, DuPont, WA (US); Dan H. Gerbus, Aloha, OR (US); Duck Young Kong, Beaverton, OR (US)

(73) Assignee: INTEL CORPORATION, SANTA CLARA, CA (US)

(21) Appl. No.: 14/750,834

(22) Filed: Jun. 25, 2015

(51) Int. Cl. H02J 7/00; H02J 7/02

(52) U.S. Cl. CPC H02J 7/0044; H02J 7/025

(57) ABSTRACT

In one example a charging sleeve for an electronic device comprises a frame to receive the electronic device and a cover slidably engaged with the frame and comprising a first section connected to a first edge of the frame, a second section connected to the first section by a first foldable joint, a third section connected to the second section by a second foldable joint, and a fourth section connected to the third section by a third foldable joint. Other examples may be described.

### BACKGROUND

The subject matter described herein relates generally to the field of electronic devices and more particularly to a wireless charging sleeve for electronic devices.

Growth in the marketplace for portable electronic devices has driven a corresponding growth in the need for wireless charging solutions. Wireless charging platforms for electronic devices typically incorporate a wireless power transmitting device which may be coupled, either by inductance or by capacitance, to a wireless power receiving device in an electronic device. However, many portable electronic devices do not incorporate a wireless power receiving device Accordingly, ancillary devices which enable wireless charging capabilities for electronic devices may find utility.

### BRIEF DESCRIPTION OF THE DRAWINGS

The detailed description is described with reference to the accompanying figures.

FIG. 1 is a schematic illustration of an electronic device which may be adapted to work with a wireless charging sleeve in accordance with some examples.

FIG. 2A is a high-level schematic, side-view illustration of a sleeve adapted to implement wireless charging with an electronic device in accordance with some examples.

FIG. 2B is a high-level schematic, side-view illustration of a sleeve adapted to implement wireless charging with an electronic device in accordance with some examples.

FIGS. 3A-3B are high-level schematic illustrations of a sleeve adapted to implement wireless charging with an electronic device in accordance with some examples.

FIGS. 4A-4B are high-level schematic illustrations of a sleeve adapted to implement wireless charging with an electronic device in accordance with some examples.

FIG. 5 is a flowchart illustrating operations in a method to implement wireless charging in accordance with some examples.

FIGS. 6-10 are schematic illustrations of electronic devices which may be adapted to implement wireless charging in accordance with some examples.

### DETAILED DESCRIPTION

Described herein are examples of a wireless charging sleeve which may be used to implement systems and methods for wireless charging with electronic devices that may not include wireless charging capabilities. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide wireless charging capabilities for electronic device(s). In some examples the subject matter described herein addresses these and other issues by providing a sleeve into which an electronic device fits. The sleeve includes a wireless power receiving device such as one or more inductive receiving coils or capacitive charge plates positioned proximate a surface of the sleeve to receive electrical power from a wireless charger, e.g., via an electromagnetic coupling. The sleeve further comprises at least one controller which may cooperate with a controller on the electronic device to manage charging operations for the electronic device. In some examples the sleeve includes a multi-part, foldable cover designed to allow the electronic device to be positioned in varying configurations while the wireless power receiving device is positioned proximate a wireless charger.

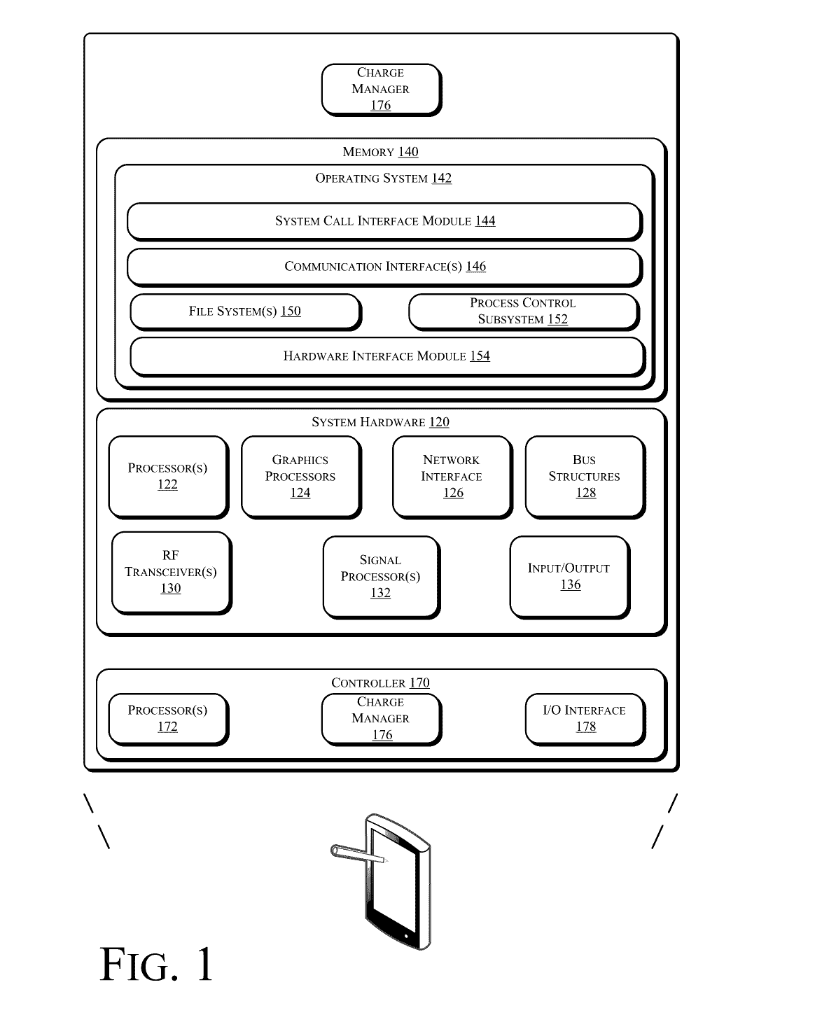

Additional features and operating characteristics of the electronic device and associated system are described below with reference to FIGS. 1-10.

FIG. 1 is a schematic illustration of an electronic device 100 which may be adapted to include a charge manager in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more input/output interfaces 136 such as, e.g., a keypad and/or a display. In some examples electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 140. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms

In the embodiment depicted in FIG. 1 the controller 170 comprises a processor 172, a charge manager 176, and an I/O interface 178. In some examples the I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples portions of the charge manager 176 may reside in the memory 140 of electronic device 100 and may be executable on one or more of the processors 122.

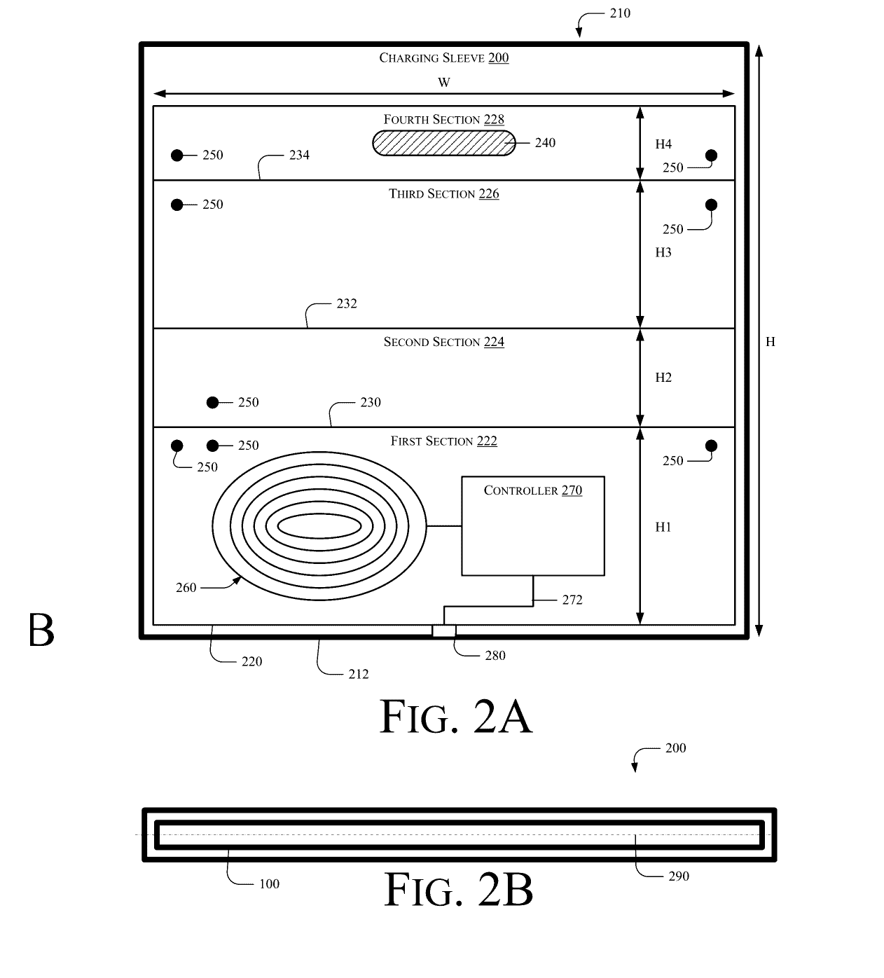

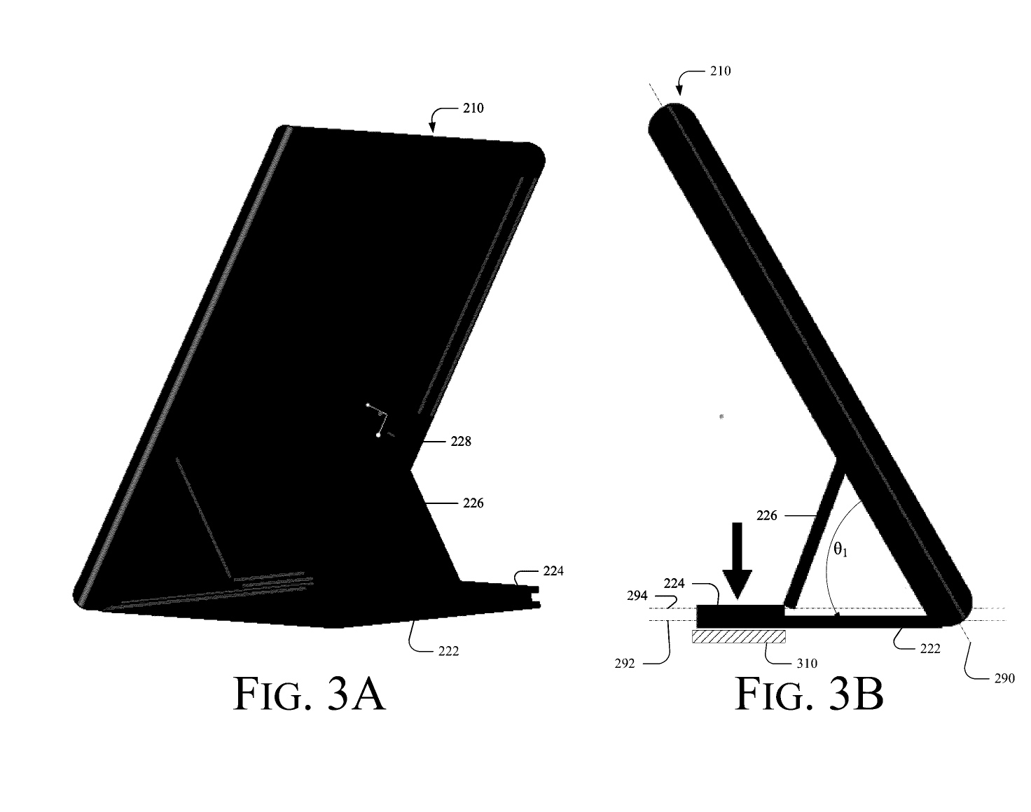

FIGS. 2A-2B, 3A-3B, and 4A-4B are high-level schematic illustrations of a wireless charging sleeve 200 adapted to implement wireless charging with an electronic device 100 in accordance with some examples. Referring to FIGS. 2A-2B, 3A-3B, in some examples a charging sleeve 200 for an electronic device 100 comprises a frame 210 to receive the electronic device 100 and a cover 220 slidably engaged with the frame 210. The cover comprises a first section 222 connected to a first edge 212 of the frame 210, a second section 224 connected to the first section 222 by a first foldable joint 230, a third section 226 connected to the second section 224 by a second foldable joint 232, and a fourth section 228 connected to the third section 226 by a third foldable joint 234.

Frame 210 may be formed from a suitable material e.g., a semi-rigid polymer, metal, or composite material. In some examples the frame 210 may be dimensioned to receive electronic device 100. A front section of the frame 210 may include a window through which a display of the electronic device 100 may remain accessible when the electronic device 100 is disposed within the sleeve 200.

In some examples the cover 220 has a width indicated by reference W in FIG. 2A. In some examples the sleeve 200 has a height indicated by reference H in FIG. 2A and the first section 222 of the cover 200 has a height indicated by reference H1 in FIG. 2A which measures between 40-45% of H. The second section 224 of the cover 200 has a height indicated by reference H2 in FIG. 2A which measures between 15-20% of H. The third section 226 of the cover 200 has a height indicated by reference H3 in FIG. 2A which measures between 25-30% of H. The fourth section 228 of the cover 200 has a height indicated by reference H4 in FIG. 2A which measures between 10-15% of H.

In some examples the first section 222 of the cover comprises a wireless power receiving device positioned proximate a surface of the cover. In the example depicted in FIG. 2A the wireless power receiving device comprises an inductive coil 260. In alternate examples the wireless power receiving device may comprise a capacitive charge plate. The wireless power receiving device 260 is coupled to a controller 270 which, in turn, is coupled to an electrical connector 280 which is adapted to establish electrical contact with the electronic device 100 when positioned in the sleeve. In some examples electrical connector 280 may also establish a data connection to allow data exchange between controller 270 and the controller 170 and/or processor(s) 122 on electronic device 100.

In one aspect the cover 220 may be folded to define a stand which holds the electronic device in various configurations. Referring to FIGS. 3A-3B, in a first configuration the cover 200 may be folded such that the second section 224 of the cover 200 folds on top of the first section 222 of the cover. In this configuration the frame 210 retains the electronic device 100 within a reference plane 290 and the cover 220 is slideable into a first position in which the first section 222 lies within a first plane 292 that defines a first interior angle (θ₁) with the reference plane 290 that measures between 50 degrees and 75 degrees and the second section 224 lies in a second plane 294 substantially parallel to the first plane 292.

As illustrated in FIG. 2A, the first section 222 and the second section 224 comprise magnets 250 positioned to secure the second section 224 to the first section 222 when the cover 220 is in the first position illustrated in FIGS. 3A-3B. Thus, in the first position depicted in FIGS. 3A-3B the electronic device 100 may be presented to a user at an angle that measures between 50 degrees and 75 degrees while the wireless power receiving device 260 in the first section 222 lies in the first plane 292 such that it can be positioned proximate a wireless power source 310.

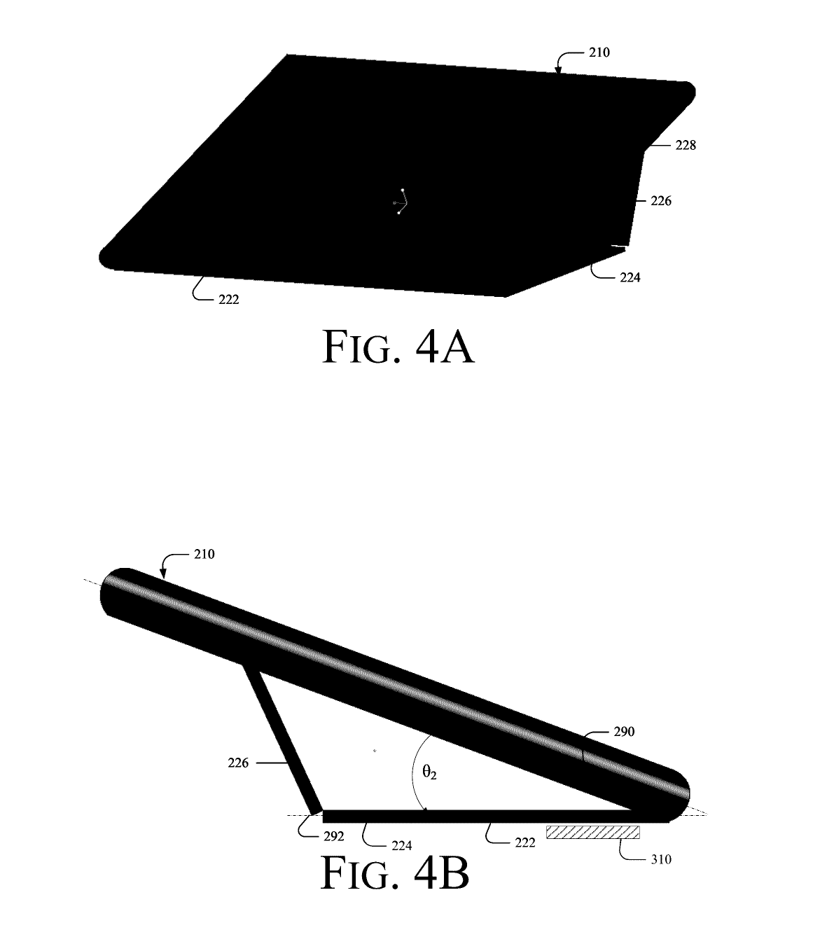

Referring to FIGS. 4A-4B, in some examples the cover 220 is slideable into a second position in which the first section 222 lies within a first plane 292 that defines a second interior angle (θ₂) with the reference plane 290 that measures between 15 degrees and 45 degrees and the second section 224 lies in a second plane 294 substantially coplanar with the first plane 292. Thus, in the second position depicted in FIGS. 4A-4B the electronic device 100 may be presented to a user at an angle that measures between 10 degrees and 45 degrees while the wireless power receiving device 260 in the first section 222 lies in the first plane 292 such that it can be positioned proximate a wireless power source 310.

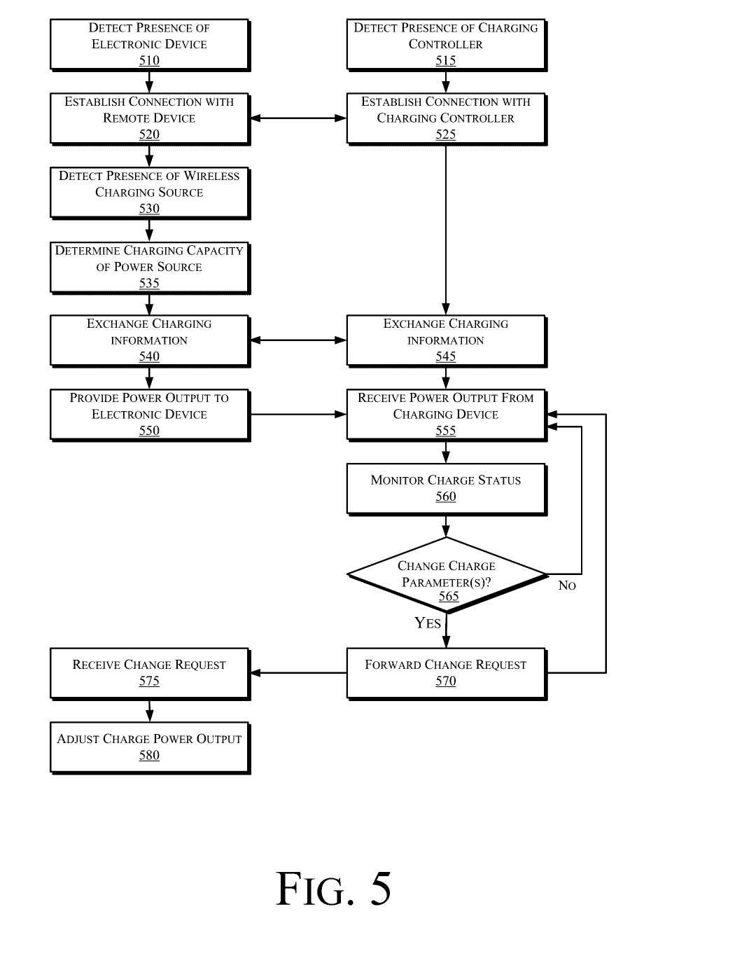

In some examples the controller 270 interacts with the charge manager 176 and one or more other components of the electronic device 100 to manage wireless charging for the electronic device 100 when the electronic device is in the wireless charging sleeve 200. FIG. 5 is a flowchart illustrating operations in a method to implement wireless charging for an electronic device 100 in sleeve 200 in accordance with some examples.

Referring to FIG. 5, at operation 510 the controller 270 detects the presence of electronic device 100 within sleeve. In some examples the controller 270 may detect a connection between electrical connector 270 and a corresponding electrical connector in electrical device 100. In further examples controller 270 may include a wireless communication capability and may detect the presence of electronic device 100 via the wireless communication capability. Similarly, at operation 515 the electronic device 100 detects the presence of charging controller 270 in sleeve 200.

At operation 520 the controller 270 in charge sleeve 200 establishes a communication connection with the electronic device 100, and similarly at operation 525 the I/O interface in controller 200 establishes a communication connection with the controller 270. The communication connection may be established via a wireless communication interface or by a wired interface.

At operation 530 the sensor(s) 210 in the controller 270 in charge sleeve 200 detects the presence of a wireless charging source. For example, controller 270 may detect a current induced in the wireless power receiving device 260 when the wireless power receiving device 260 is positioned proximate a wireless power source 310.

At operation 535 the controller 270 may determine a charging capacity of the wireless power source 310. For example, the controller 270 may measure the power output of wireless power receiving device 260 when positioned proximate the wireless power source 310.

At operations 540-545 the controller 270 in charge sleeve 200 and the charge manager 176 in electronic device 100 exchange charging information for the electronic device 100. By way of example, the controller 270 may provide the charge manager 176 with the charging capacity of the wireless power source 310 as determined in operation 535. In turn, charge manager 176 may provide controller 270 with at least one of a charge level of the electronic device 100, an operational status of the electronic device 100, or a power consumption level of the electronic device 100.

At operation 550 the controller 270 provides power generated by coupling wireless power receiving device 260 to wireless power source(s) 310. In operation, the controller 270 may monitor the power output of the wireless power receiving device 260, which may be transmitted to the electronic device 100 via the communication connection established at operations 520-525.

At operation 555 the electronic device 100 receives the power output from the wireless power receiving device 260. At operation 560 the charge manager 176 in electronic device monitors the charge status of electronic device 100. If, at operation 565 the charge status does not indicate that any charge parameters should be adjusted then control passes back to operation 555. Thus, operations 555 to 565 define a loop pursuant to which the charge manager 176 monitors charging operations between the wireless power receiving device(s) 260 in the sleeve 200 and the electronic device 100.

By contrast, if at operation 565 the charge status indicates that one or more charge parameters should be adjusted then control passes to operation 570 and the charge manager 176 forwards a change request to the controller 270. At operation 575, the controller 270 receives the request transmitted by the charge manager 176 at operation 570. At operation 580 the controller modifies one or more aspects of the charging operation in response to the change request.

In some examples the controller may adjust the power output of the wireless power receiving device 260 in response to a change request which indicates that the electronic device 100 is fully charged and does not require charging. In other examples the controller 270 may disconnect the wireless power receiving device 260 from the controller 270 such that no power generated by the wireless power receiving device is provided to the electronic device 100 in the sleeve 200.

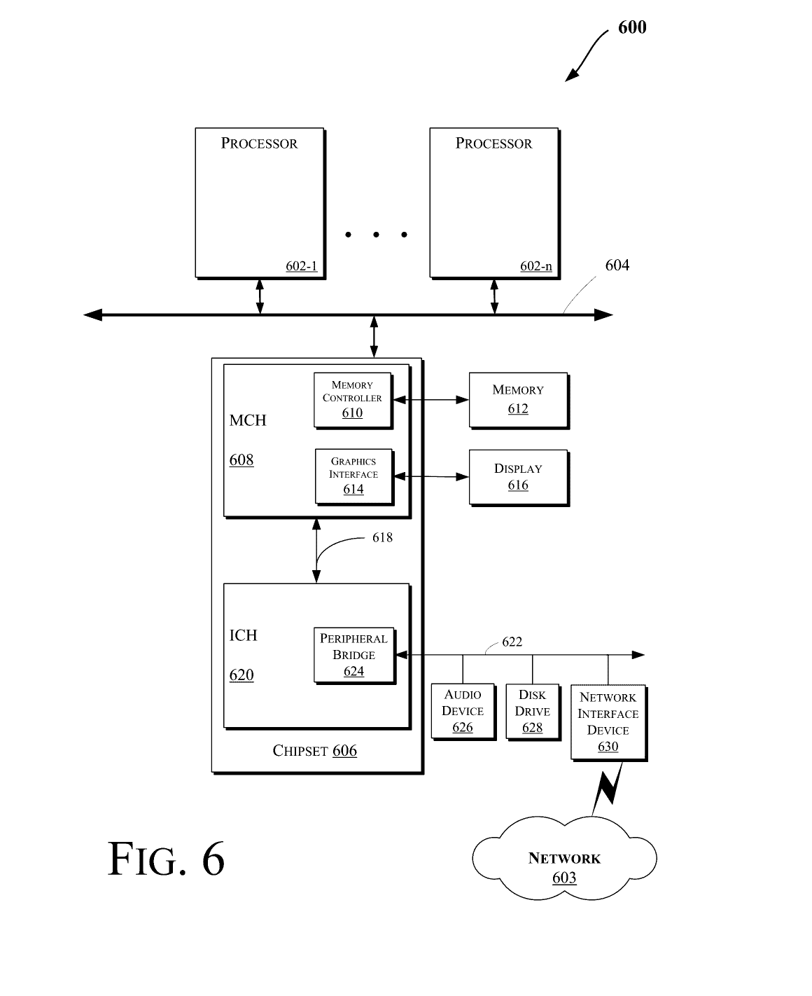

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

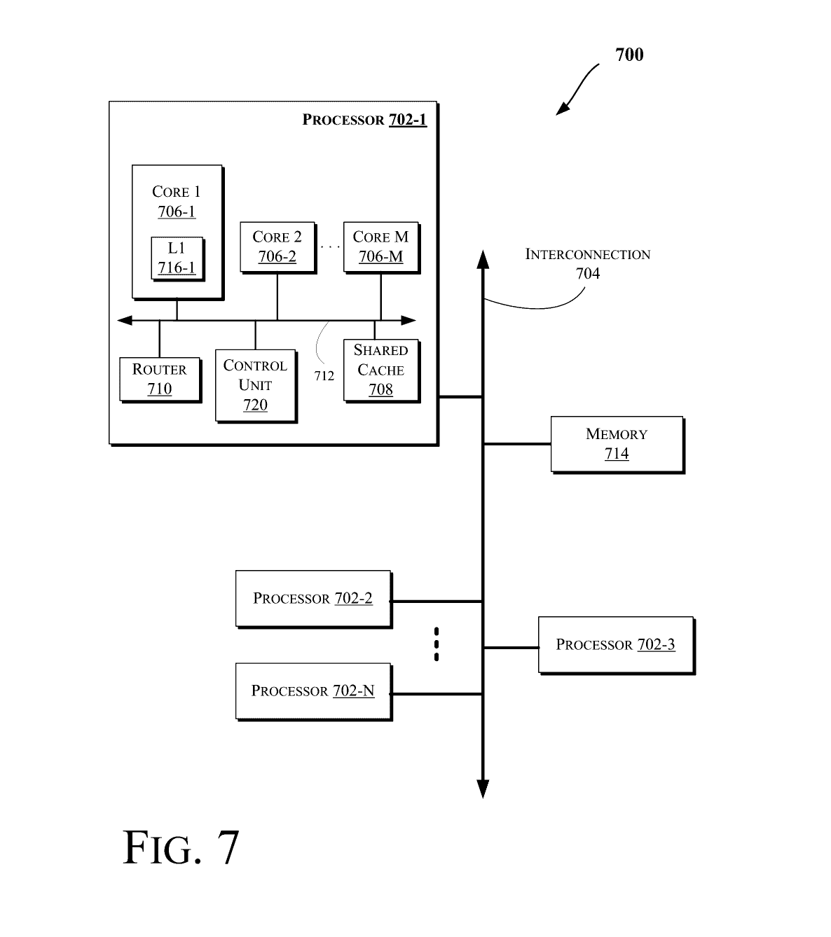

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

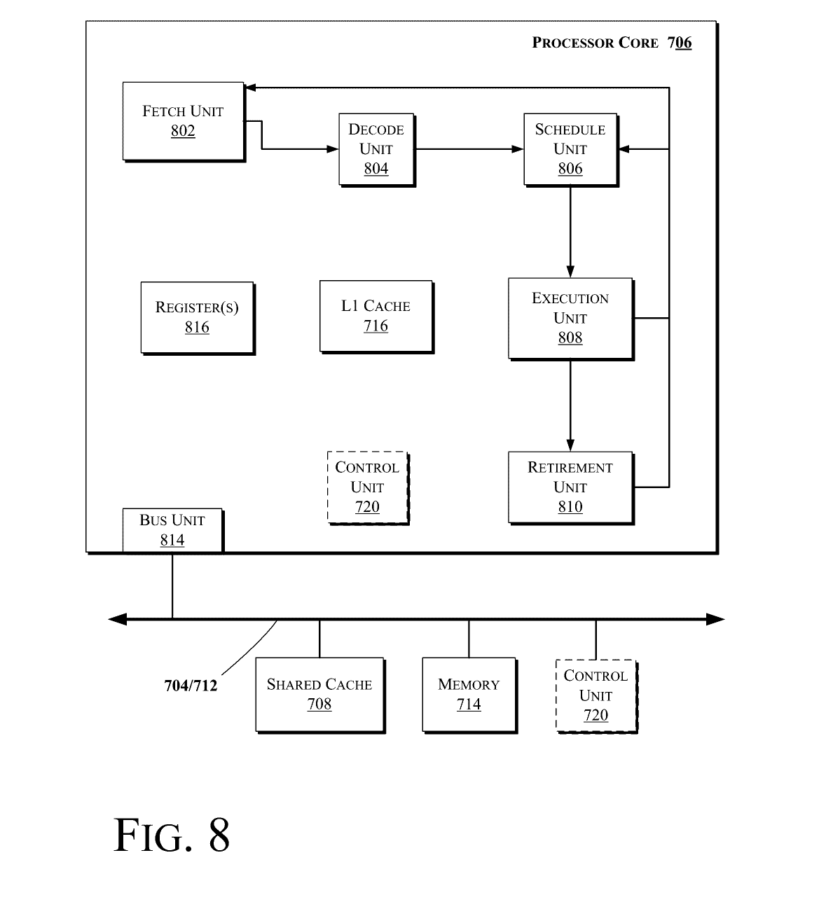

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

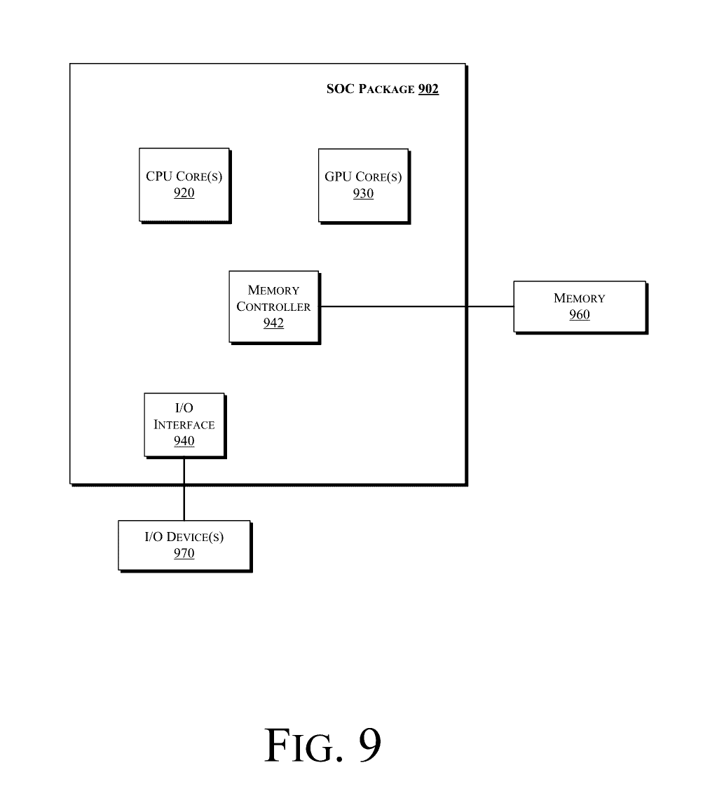

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

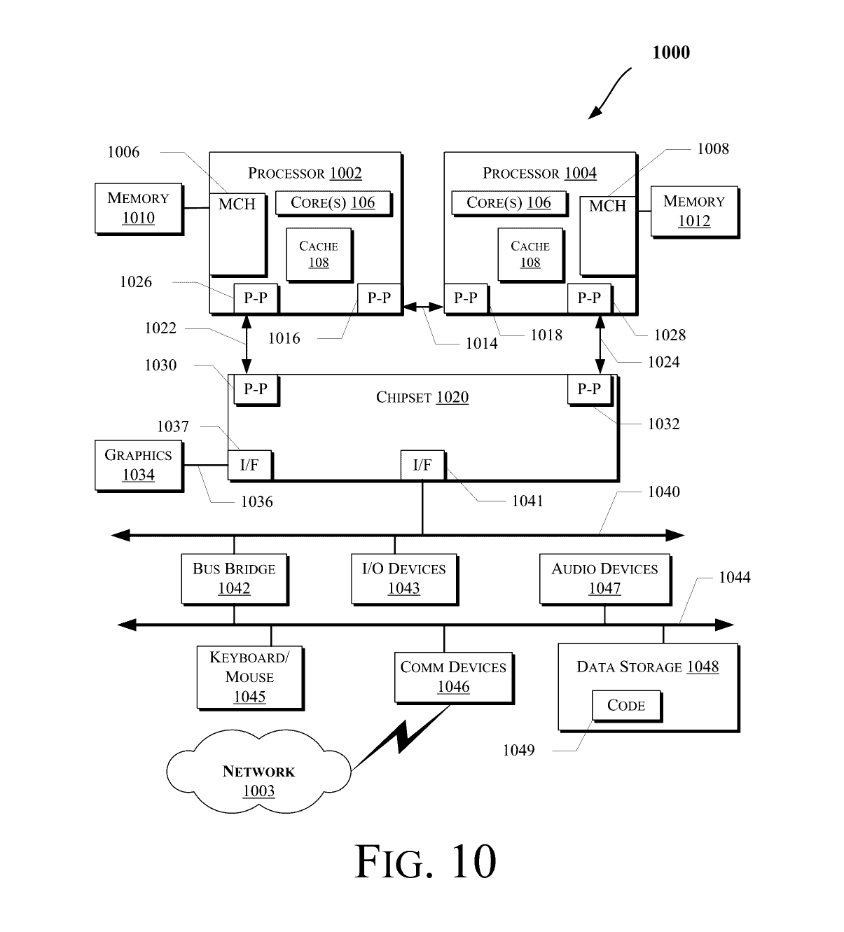

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertain to further examples.

Example 1 is a charging sleeve for an electronic device, comprising a frame to receive the electronic device and a cover slidably engaged with the frame and comprising a first section connected to a first edge of the frame, a second section connected to the first section by a first foldable joint, a third section connected to the second section by a second foldable joint, and a fourth section connected to the third section by a third foldable joint.

In Example 2, the subject matter of Example 1 can optionally include an arrangement in which the frame retains the electronic device within a reference plane and the cover is slideable into a first position in which the first section lies within a first plane that defines a first interior angle (θ1) with the reference plane that measures between 50 degrees and 75 degrees and the second section lies in a second plane substantially parallel to the first plane.

In Example 3, the subject matter of any one of Examples 1-2 can optionally include an arrangement in which the first section and the second section comprise magnets positioned to secure the second section to the first section when the cover is in the first position.

In Example 4, the subject matter of any one of Examples 1-3 can optionally include an arrangement in which the cover is slideable into a second position in which the first section lies within a first plane that defines a second interior angle (θ2) with the reference plane that measures between 15 degrees and 45 degrees and the second section lies in a second plane substantially coplanar with the first plane.

In Example 5, the subject matter of any one of Examples 1-4 can optionally include an arrangement in which first section of the cover comprises a wireless power receiving device positioned proximate a surface of the cover.

In Example 6, the subject matter of any one of Examples 1-5 can optionally include an arrangement in which the wireless power receiving device comprises a coil.

In Example 7 the subject matter of any one of Examples 1-6 can optionally include an arrangement in which the charging sleeve comprises a controller.

In Example 8, the subject matter of any one of Examples 1-7 can optionally include an arrangement in which the charging sleeve comprises an electrical connector to establish an electrical connection with an electronic device coupled to the charging sleeve.

In Example 9, the subject matter of any one of Examples 1-8 can optionally include an arrangement in which the controller is coupled to the wireless power receiving device and to the electrical connector.

In Example 10, the subject matter of any one of Examples 1-9 can optionally include an arrangement in which the controller comprises logic, at lease partially including hardware logic, to detect a presence of a wireless charging power source proximate the wireless power receiving device and determine a charging capacity of the wireless charging power source.

In Example 11, the subject matter of any one of Examples 1-10 can optionally include an arrangement in which the controller comprises logic, at lease partially including hardware logic, to detect a presence of an electronic device proximate the controller.

In Example 12, the subject matter of any one of Examples 1-11 can optionally include an arrangement in which the controller comprises logic, at lease partially including hardware logic, to establish a communication connection with an electronic device coupled to the charging sleeve, receive, via the communication connection, charging information for the electronic device, and use the charging information to manage a charging operation for the electronic device.

In Example 13, the subject matter of any one of Examples 1-12 can optionally include an arrangement in which the charging information comprises at least one of a charge level of the electronic device, an operational status of the electronic device, a power consumption level of the electronic device.

In Example 14, the subject matter of any one of Examples 1-13 can optionally include an arrangement in which the controller comprises logic, at lease partially including hardware logic, to provide power output from the wireless power receiving device to the electronic device.

In Example 15, the subject matter of any one of Examples 1-14 can optionally include an arrangement in which the controller comprises logic, at lease partially including hardware logic, to receive, via the communication connection, a request to change a charging parameter, and in response to the request, to modify a charging operation for the electronic device.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A charging sleeve for an electronic device, comprising:
a frame to receive the electronic device; and
a cover slidably engaged with the frame and comprising:
a first section connected to a first edge of the frame;
a second section connected to the first section by a first foldable joint;
a third section connected to the second section by a second foldable joint; and
a fourth section connected to the third section by a third foldable joint.

2. The charging sleeve of claim 1, wherein:
the frame retains the electronic device within a reference plane; and
the cover is slideable into a first position in which:
the first section lies within a first plane that defines a first interior angle (θ₁) with the reference plane that measures between 50 degrees and 75 degrees; and
the second section lies in a second plane substantially parallel to the first plane.

3. The charging sleeve of claim 2, wherein the first section and the second section comprise magnets positioned to secure the second section to the first section when the cover is in the first position.

4. The charging sleeve of claim 2, wherein:
the cover is slideable into a second position in which:
the first section lies within a first plane that defines a second interior angle (θ₂) with the reference plane that measures between 15 degrees and 45 degrees; and
the second section lies in a second plane substantially coplanar with the first plane.

5. The charging sleeve of claim 1, wherein first section of the cover comprises a wireless power receiving device positioned proximate a surface of the cover.

6. The charging sleeve of claim 5, wherein the wireless power receiving device comprises a coil.

7. The charging sleeve of claim 6, wherein the charging sleeve comprises a controller.

8. The charging sleeve of claim 7, wherein:
the charging sleeve comprises an electrical connector to establish an electrical connection with an electronic device coupled to the charging sleeve.

9. The charging sleeve of claim 8, wherein:
the controller is coupled to the wireless power receiving device and to the electrical connector.

10. The charging sleeve of claim 9, wherein the controller comprises logic, at lease partially including hardware logic, to:
detect a presence of a wireless charging power source proximate the wireless power receiving device; and
determine a charging capacity of the wireless charging power source.

11. The charging sleeve of claim 9, wherein the controller comprises logic, at lease partially including hardware logic, to:
detect a presence of an electronic device proximate the controller.

12. The charging sleeve of claim 9, wherein the controller comprises logic, at lease partially including hardware logic, to:
establish a communication connection with an electronic device coupled to the charging sleeve;
receive, via the communication connection, charging information for the electronic device; and
use the charging information to manage a charging operation for the electronic device.

13. The charging sleeve of claim 12, wherein the charging information comprises at least one of:
a charge level of the electronic device;
an operational status of the electronic device;
a power consumption level of the electronic device.

14. The charging sleeve of claim 12, wherein the controller comprises logic, at lease partially including hardware logic, to provide power output from the wireless power receiving device to the electronic device.

15. The charging sleeve of claim 12, wherein the controller comprises logic, at lease partially including hardware logic, to:
receive, via the communication connection, a request to change a charging parameter; and
in response to the request, to modify a charging operation for the electronic device.
